(19) United States
(12) Patent Application Publication
(10) Pub. No.: US 2002/0169836 A1
(43) Pub. Date: Nov. 14, 2002

(54) Methods and devices for providing pooled personal introduction services

(76) Inventors: Grant Hood, Etobicoke (CA); Craig Priest, Etobicoke (CA)

Correspondence Address: BAKER & BOTTS, 30 ROCKEFELLER PLAZA, NEW YORK, NY, 10112

(21) Appl. No.: 09/825,412

(22) Filed: Apr. 3, 2001

(51) Int. Cl. G06F 15/16

(52) U.S. Cl. 709/206; 709/207

(57) ABSTRACT

A method device and software facilitating exchange of messages at a computerized message exchange system are disclosed. The computerized message exchange system serves users associated with different introduction service providers. The system allows the different introduction service providers to pool users, so that users associated with a first service provider have access to greetings of users associated with other service providers, serviced at the system. Conveniently, access to greetings of various service providers and various users may be filtered, so that users of the first service provider only have access to users of selected other service providers, and to users having sanctioned interests.

### FIELD OF THE INVENTION

The present invention relates to personal introduction services, and more particularly to methods and devices for enabling multiple introduction service providers to operate using shared resources.

### BACKGROUND OF THE INVENTION

Over the past several years, computer and telephone based introduction services have become a popular way to meet other people. These services offer users a convenient and time-efficient way to contact, and eventually meet others for romantic or social purposes.

Typically, users of such services can access a main server operated by a service provider, usually through a telephone or a computer terminal. By way of such access, each user can browse a pool of personal greetings and personal information left by others; create his or her own personal greeting and personal information profile; check for messages sent by others; and send personal messages to others.

Often users of a particular introduction service are dissatisfied that not enough others have joined that same service. Consequently, users who have already joined and possibly paid for a particular service may find it difficult to meet other users matching their preferences. Although a user may, of course, join other introduction services, thereby gaining access to additional user pools, this may entail increased financial costs, as well as increased effort and time required to access and to use multiple introduction services. Moreover, with the proliferation of introduction services, many user pools do not have many users, thus exacerbating the problem of meeting other users matching a particular user's preferences. Consequently, the user may be discouraged from using any introduction service.

The proliferation of, and low barriers to entry for introduction services has also created difficulties for the providers of these services. With different introduction service providers all vying for the same group of potential users, it has become very difficult for introduction service providers to target and attract users. Introduction service providers must therefore invest more effort and money in advertising and distinguishing their services. Disadvantageously, the high cost of advertising and marketing makes it impractical to advertise in every media outlet, thereby making it impractical to reach all potential users. Additionally, introduction services must continually offer more and more incentives, such as promotional free usage, in order to attract new users.

Regardless of the number of users they actually serve, introduction service providers must typically still undertake a substantial investment to set up the infrastructure to support such a service. Hardware needed to implement an automated introduction service must be acquired; premises to house the system must be purchased or rented; and the personnel needed to manage and maintain the system has to be hired.

As a consequence, those who offer introduction services have begun to pool their resources, with a single infrastructure host providing services for multiple introduction services, typically using common hardware. So for example, a single introduction service host may provide computer or telephone introduction services under several brands. Each brand, in turn, may identify a particular introduction service provider. A service provider may be a local newspaper, a club or the like. In this way the multiple service providers can each appear to provide a distinct introduction service. Users of one introduction service may, for example, contact the service provider by way of a particular computer network address. Additionally, users of one introduction service benefit from an increased pool of users. That is, users associated with one service provider may share access to many users associated with other service providers.

Unfortunately, not all service providers appeal to the same group of users. Thus pooling of resources often has the unforeseen drawback that some users may be exposed to users with dissimilar and perhaps incompatible interests. For example, one introduction service may serve to provide casual introductions, while another may serve to provide discreet encounters. Users of the two services may not wish access to each other. In such circumstances pooling may be inappropriate.

Accordingly, it would be desirable to allow introduction service providers to reduce their infrastructure and overhead costs, while offering users of different introduction service providers access to a large pool of other users, without alienating the users.

### SUMMARY OF THE INVENTION

It is therefore an object of the present invention to allow different introduction service providers to pool users, so that users of associated with a first service provider have access to greetings of users associated with other service providers. Conveniently, access to greetings of various service providers and various users may be filtered, so that users of the first service provider only have access to users of selected other service providers, and to users having sanctioned interests.

In accordance with an aspect of the present invention, there is provided a method of facilitating exchange of messages at a computerized message exchange system. The method includes storing a first plurality of greetings at the system. Each of these first plurality of greetings is associated with users of a first introduction service provider. The method further includes storing a second plurality of greetings at the server. Each of the second plurality of greetings associated with a user of an introduction service provider, different from said first introduction service provider. The method allows users associated with the first introduction service provider, access to selected ones of the second plurality of greetings, based on criteria associated with an originator of each of said selected ones of said second greetings, and criteria set by the first introduction service provider.

Conveniently, the method may be performed by software stored on a computer readable medium.

Other aspects and features of the present invention will become apparent to those of ordinary skill in the art, upon review of the following description of specific embodiments of the invention in conjunction with the accompanying figures.

### BRIEF DESCRIPTION OF THE FIGURES

In figures which illustrate, by way of example, embodiments of the present invention,

FIG. 1 is a simplified block diagram of computer workstations and telephone sets in communication with an introduction service messaging system, exemplary of an embodiment of the present invention;

FIG. 2 illustrates an interactive voice response (IVR) unit forming part of the system of FIG. 1;

FIG. 3A illustrates the interrelationship of various databases stored at the system of FIG. 1;

FIG. 3B illustrates an example user personal information record forming part of a greeting database hosted by the system of FIG. 1;

FIG. 3C illustrates an example message record forming part of a voice message database hosted by the system of FIG. 1;

FIG. 3D illustrates an example administrative record forming part of a user accounts database hosted by the system of FIG. 1;

FIG. 3E illustrates an example service provider record forming part of a service provider database hosted by the system of FIG. 1; and

FIG. 3F illustrates an HTML record forming part of an HTML database hosted by the system of FIG. 1

FIGS. 4-5 are a flow charts illustrating exemplary steps performed by the system of FIG. 1 to allow users access to the system of FIG. 1;

### DETAILED DESCRIPTION

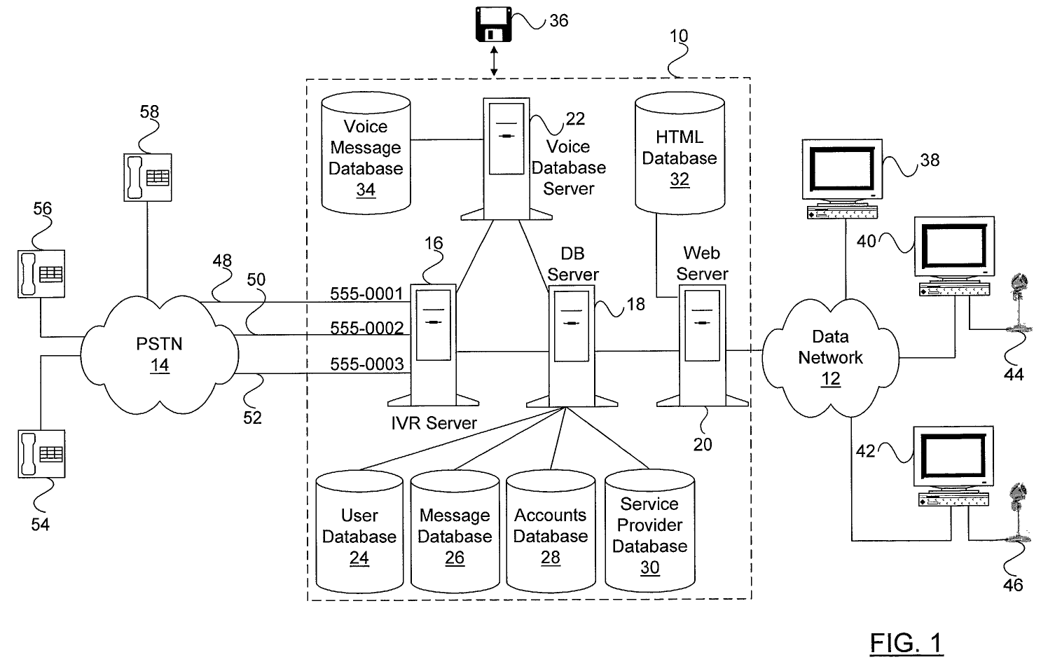

FIG. 1 illustrates a messaging system 10 that acts as host for multiple introduction service providers, to provide introduction services to end users. System 10 is exemplary of an embodiment of the present invention. End users associated with the service providers may access system 10 by way of a data network 12, and also by way of telephone network 14. End-users may use system 10 to meet each other and exchange messages. As will readily be apparent, system 10 could easily provide introduction services solely by way of telephone network 14, or by way of data network 12. End users are encouraged to use system 10, by service providers that promote introduction services. Multiple service providers may contract with the operator of system 10, to host services at system 10. In this way, the multiple service providers may share physical resources, and may even provide introduction services without ownership or administration of hardware and software.

In the illustrated embodiment, system 10 includes an interactive voice response (“IVR”) server 16, in communication with a database server 18, and a voice message database server 22. Further, a web server 20 is interconnected with database server 18. IVR server 16, database server 18, voice messaging database server 22, and web server 20 are preferably interconnected to each other by of a computer network such as a local area network (“LAN”).

IVR server 16 is in communication with telephone network 14. Telephone network 14 is preferably the public switched telephone network (“PSTN”). IVR server 16 allows users to access system 10 by way of telephone network 14. IVR server 16 is connected to telephone network 14 through communication links 48, 50, and 52.

Each of the illustrated communication links 48, 50 and 52 is preferably a conventional telephone line associated with a unique dial number, which may in turn be associated with an introduction service provider using system 10. For example, link 48 may be associated with telephone access number 555-0001. This phone number may be dialled by end users subscribing to one of the introductions services in order to access system 10. Similarly, links 50 and 52 may be associated with other phone access numbers, such as the numbers 555-0002 and 555-0003, respectively. Each of these phone numbers may be used by end users associated with two additional introduction service providers to access system 10. Additional communication links may connect IVR server 16 to telephone network 14. Each additional communication link is preferably associated with a different telephone access number. Those versed in the art will realize, of course, that only a single physical communication link may be used connect IVR server 16 to telephone network 14, and that this single communication link may correspond to a plurality of phone access numbers that can be used to access system 10.

Example user telephones 54, 56, and 58 interconnected with telephone network 14 are further illustrated. End users of system 10 can communicate instructions and enter information by pressing keys on a dual tone, multi-frequency (“DTMF”) touchpad on telephone 54, 56 or 58. For clarity, only three telephones are illustrated. Of course, system 10 could be accessed by any other telephone in communication with telephone network 14. End-users using telephones 54, 56, or 58 may access system 10 by dialling one of the various access numbers associated with links 48, 50, or 52.

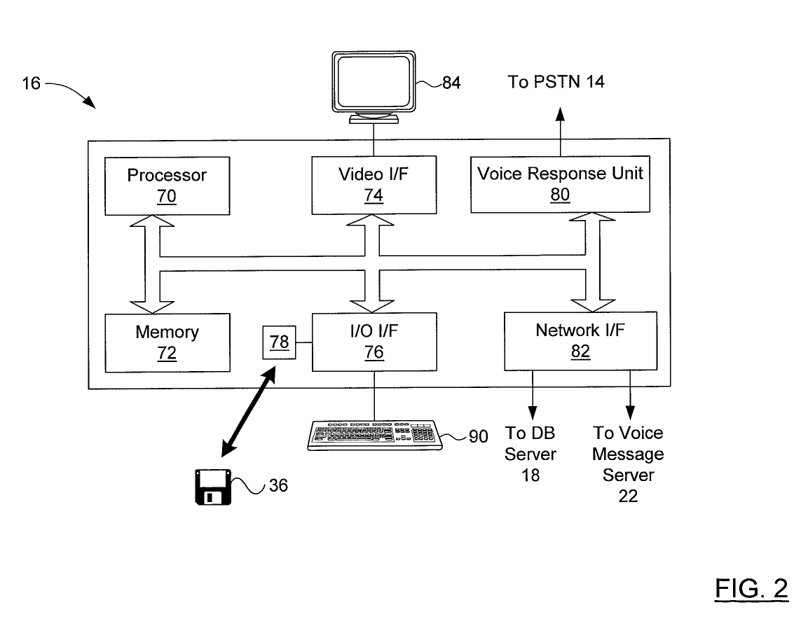

FIG. 2 schematically illustrates an exemplary embodiment of IVR server 16. IVR server 16 is preferably a conventional computing device that stores and executes suitable software to act as an interactive voice response processor. As such, IVR server 16 includes processor 70 such as an INTEL PENTIUM™ class CPU, and memory 72 including random access memory (RAM) and persistent storage memory for storing and executing computer programs. Suitable data and computer programs may be loaded into IVR server 16 from computer readable medium 36 (also illustrated in FIG. 1), by way of a suitable I/O device 78 and interface 76 forming part of IVR server 16. A network interface 82 connects IVR server 16 to voice message database server 22, (FIG. 2) and database server 18, by way of a local area network (not shown). Optionally, IVR server 16 includes a video I/F 74 and monitor 84. Keyboard 90 may further optionally be interconnected with interface 76.

IVR server 16 preferably also includes a voice response unit (VRU) 80 in communication with processor 70. VRU 80 may be a Dialogic PathFinder IVR, to provide the physical connection between IVR server 16 and telephone network 14. VRU 80 may signal to processor 70 that a user's call is waiting to be serviced when an incoming call arrives. In addition, VRU 80 synthesizes voice or speech data received from either memory 72, or from interconnected server 22, as detailed below, for transmission to a recipient in communication with telephone network 14. VRU 80 may further include storage medium in the form of read-only-memory, or some other suitable medium, to hold a repository of common voice sequences in a suitable computer readable sound data format that can readily be converted into speech signals.

VRU 80 is preferably also capable of decoding DTMF tones corresponding to number keys on a telephone touchpad. VRU 80 receives signals corresponding to a user's instructions and information, as input over telephone network 14. VRU 80 converts these signals into computer readable format, and preferably provides these to processor 70 for further processing. VRU 80 preferably also includes an analog to digital converter (A/D), to convert speech segments articulated by a user, like a personal greeting, or a voice message, into a digital speech signal that can thereafter be converted into a computer readable sound format using a suitable coder/decoder. Converted speech segments can then be stored within memory 72 or on database server 18.

Memory 72 of IVR server 16 stores software including voice prompt sequences that prompt users for requisite information, and software for storing user voice response segments in a computer readable sound format formed by a suitable CODEC. These voice response segments are used to provide voice prompts and information to users accessing system 10 through a telephone. Voice response sequences transmitted to users are preferably segments that are unique to the particular service provider the user is subscribing to. As such, the voice response segments may greet the user, announce the name of the service and the name of the service provider, and instruct the user to enter information and make selections particular to that service provider, as detailed below. The type of information requested by IVR server 16 and the prompted selections will depend on the particular service provider.

Web server 20, illustrated in FIG. 1 connects system 10 with computer data network 12. Data network 12 is preferably a packet switched data network, such as the public Internet. Web server 20 may be connected to data network 12 by way of a T1, DSL or other suitable interface (not illustrated) in a conventional manner.

Web server 20 has a hardware architecture similar to that of IVR server 16, and includes a processor and memory including random access memory (RAM) and persistent storage memory for storing and executing computer programs. Suitable data and computer programs may be loaded into web server 20 from a computer readable medium, such as computer readable medium 36 (illustrated in FIG. 1), by way of a suitable I/O device and interface forming part of web server 20. A network interface connects web server 20 to data network 12. A further network interface may interconnect web server 20 to database server 18, by way of a local area network (not shown).

Persistent memory at web server 20 may store suitable Apache™, Netscape™ or similar server software, for execution, adapting web server 20 to act as a conventional hyper text transfer protocol (HTTP) server, and thus provide a plurality of home pages for access by network interconnected computing devices. Each home page may correspond to a different service provider that allows the end users subscribing to its service to access system 10 through data network 12. In order to accomplish this, each home page hosted by web server 20 is preferably associated with a different uniform resource locator (URL) that corresponds to web server 20. Domain names associated with URL addresses may be registered by the various service providers, and stored at network domain name servers (not illustrated). Thus, network queries over data network 12 to the various URL addresses are directed to web server 20. Web pages that make up these home pages may be implemented using one of the conventional web page languages such as hypertext mark-up language (“HTML”), Java, javascript or the like. These web pages may also be stored at web server 20, within a database 32, as detailed below, and can be provided to computing devices in communication with web server 20, in response to receiving a network request directed to an associated URL.

Web pages provided to computing devices in communication with system 10 typically provide users with information about a service provider's offerings, and allow end users to make selections and provide information by clicking on icons and hyperlinks, and by entering data into information fields. As such, service provider web pages are typically designed and programmed by the service providers, and hosted by system 10. This data allows the home pages of different service providers to have completely different appearances and offer users different options and features. For example, some service providers may allow users using their services to enter only text-based data. Other service providers may allow users to enter both text and sound data. As will become apparent, once users respond to presented home pages, data is sent back to web server 20 where it can be processed.

Database server 18 illustrated in FIG. 1 is preferably also a conventional network aware computing device, including a processor, computer readable memory, and a network interface. As such, database server 18 stores and executes a conventional network aware operating system such as Microsoft Windows NT operating system, a Unix operating system, or the like. As well, database server 18 includes a conventional filesystem, preferably controlled and administered by the operating system governing overall operation of database server 18. This filesystem preferably hosts a user database 24, a message database 26, a user accounts database 28, and a service provider database 30, detailed below. Database server 18 provides information contained in these databases to requesting computing devices. If needed, database server 18 may of course host other databases. Software programs to process requests made by interconnected computing devices may be stored in persistent storage memory for execution by database server 18. Similarly, software adapting database server 18 to perform in manners exemplary of the present invention, including the operating system, is preferably also stored within persistent storage memory at database server 18. These and other software applications may be loaded into persistent storage memory of database server 18 from computer readable medium 36.

Exemplary workstations 38, 40, and 42 interconnected with data network 12 are also illustrated in FIG. 1. Workstations 38, 40, and 42 may also be connected to data network 12 by way of a modem or other suitable network interfaces. Workstations 38, 40, and 42 are preferably conventional network aware computing devices. By way of example, workstations 40 and 42 each includes a microphone 44 and 46 and related interfaces, whereas workstation 38 does not include a microphone.

Workstations 38, 40, and 42 may access system 10 by way of data network 12 and web server 20. As such, workstations 38, 40, and 42 typically store and execute network aware operating systems including protocol stacks, such as TCP/IP stack, and internet web browsers such as Microsoft Internet Explorer™, Netscape™, or Opera™ browsers. Software may be loaded into memory of workstations 38, 40, and 42 by way of computer readable media (not illustrated).

Again, for clarity of explanation only three workstation 38, 40, and 42, in communication with system 10 are illustrated. As will be appreciated, system 10 could be accessed by any computing device in communication with data network 12.

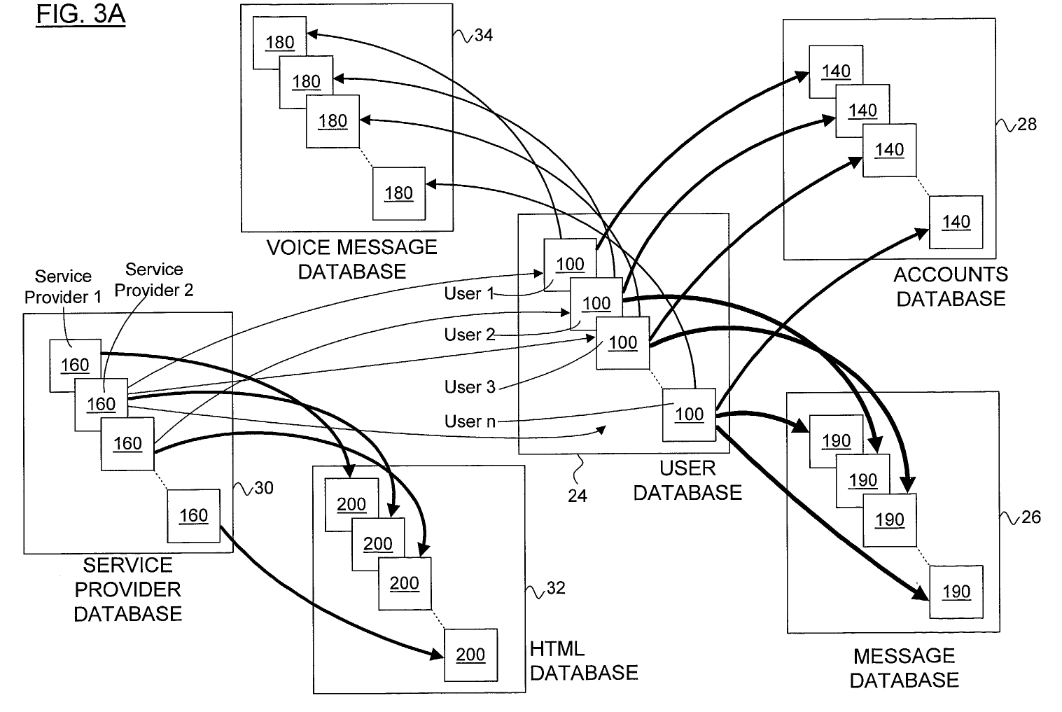

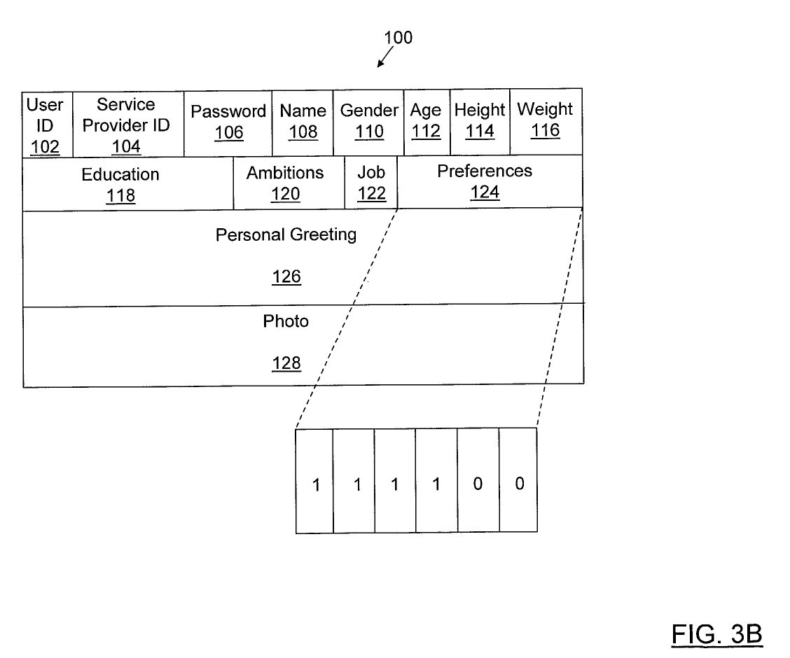

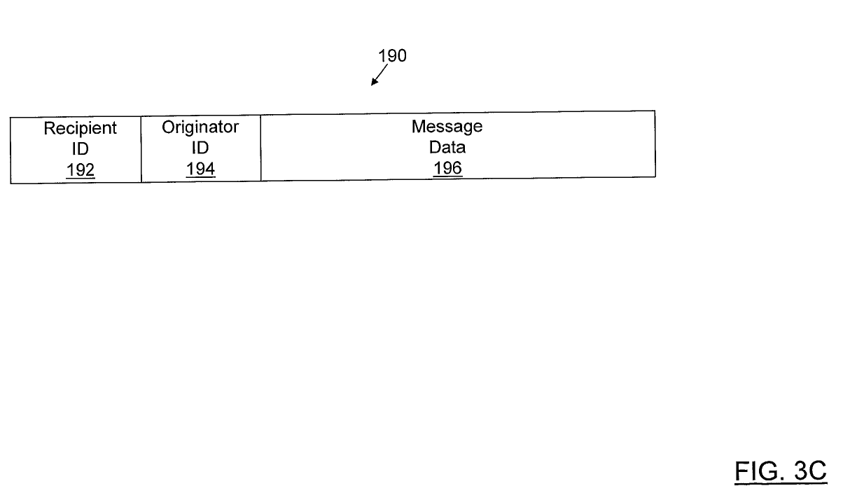

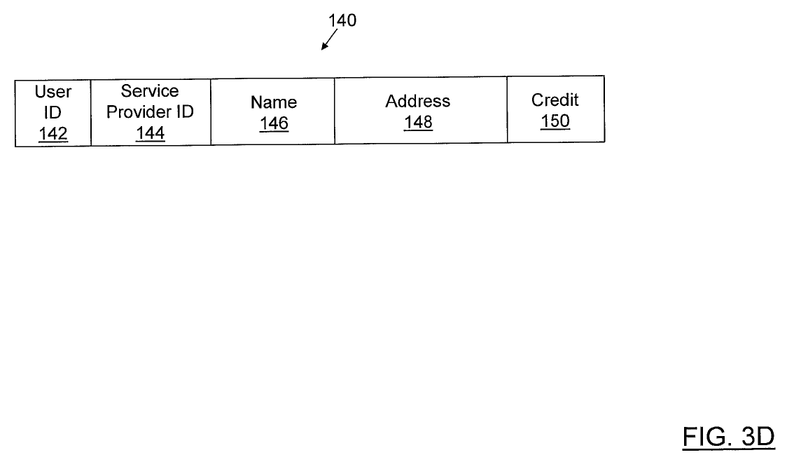

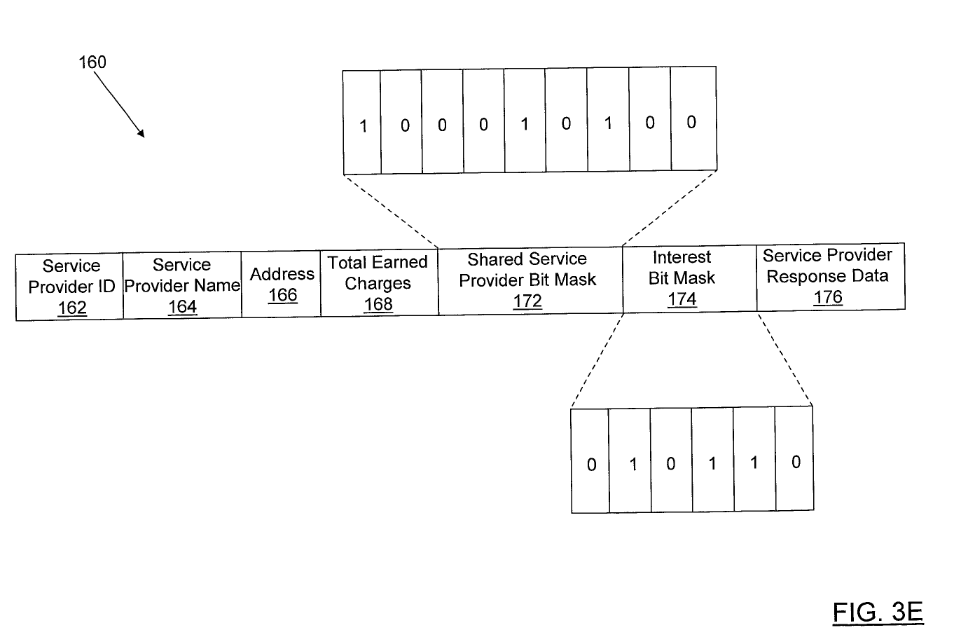

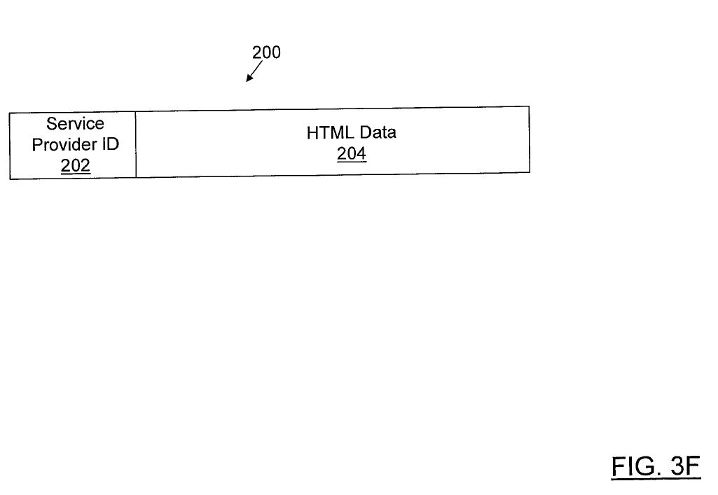

Example records of databases 24, 26, 28, 30 and 32 are more particularly illustrated in FIGS. 3B, 3C, 3D, 3E and 3F. FIG. 3B illustrates an example end-user personal information record 100 forming part of the user database 24 hosted by the server of FIG. 1. FIG. 3C illustrates an example message record forming part of the message database 26 hosted by system 10. FIG. 3D illustrates an example administrative record forming part of the accounts database 28 hosted by the server of FIG. 1. FIG. 3E illustrates an example service provider record forming part of the service provider database 30 hosted by database server 18. FIG. 3F illustrates an example HTML record forming part of HTML database 32 hosted by server 20.

FIG. 3A illustrates the interrelationship of records within databases 24, 26, 28, 30, 32 and 34. As illustrated in FIG. 3A, each service provider record 160 is associated with multiple users, and therefore multiple personal information records 100 within user database 24. Moreover, each service provider record 160 is associated with an HTML data record 200 stored within HTML database 32. Each personal information record 100, in turn may be associated with a single record 180 within voice message database 34, one or more message records 190 within database 26, and a single administrative record 140 within database 28.

User database 24 preferably includes a plurality of personal information records 100 each corresponding to a known user of system 10. Personal information records 100 store information about each user associated with system 10. An example personal information record 100 is illustrated in FIG. 3B. Specifically, personal information record 100 preferably includes a user ID field 102 that contains a unique identification number that allows database server 18 to easily index and access record 100. Record 100 preferably also includes a service provider ID field 104 that identifies the particular service provider with which a particular user is associated. Service provider ID field 104 preferably contains a unique numerical identifier of a service provider hosted by system 10.

Software adapts database server 18 to use the contents of field 104 to determine the nature of service to be provided to the particular user associated with record 100 and to limit the ability of other users of system 10 wishing to browse the contents of record 100. User information record 100 preferably also contains password field 106 containing a password that is preferably known only to the user associated with record 100. Name field 108 contains a name or nickname of the user. Additionally, record 100 includes several fields containing personal attributes of an associated user including gender field 110, detailing the user's gender; age field 112 detailing the user's age; height field 114, and weight field 116, detailing the user's height and weight, respectively; education field 118 providing information about the user's educational background; ambition field 120 listing the user's ambitions; job field 122 describing the user's occupation; and preferences field 124 containing information about the characteristics of others that the particular user is seeking to meet. Record 100 further includes personal greeting field 126 which may store a personal greeting stored in a computer readable format, or a pointer to such a greeting record 180 within database 34 (FIG. 3A). The format of greeting 180 and database 34 are not explicitly detailed. The greeting is provided by the user associated with record 100. The greeting may be stored as either a pre-recorded greeting in a suitable sound data format such as G.711, G.726 or the like, or a text-based greeting, or a combined text and sound greeting. Record 100 may further optionally include a photo field 128 that may contain image data in one of several computer readable formats. Field 128 may for example store a JPEG, or GIF of a photo of an associated user.

Preference field 124, when populated reflects the nature of a user's interest in use of the service. Preferably, a single bit is used for each of a predefined number of preferences. For example, field 124 may reflect if a user is looking for friendship, a long lasting relationship, a casual encounter, a same-sex relationship, or the like. Each of these interests is signified by a single bit within field 124. At a later point, this field 124 may be used to screen other users' access to a particular user.

Message database 26, stores a plurality of message records 190. Each message record 190 represents a message originated by one user of system 10, for receipt by another user of system 10. An example message record is illustrated in FIG. 3C. As illustrated, each record 190 includes an identifier of an intended message recipient in field 192, and an identifier of a message originator in field 194. Identifiers stored in fields 192 and 194 correspond to user identifiers stored in field 102 of a corresponding user identifier record 100 in user database 24. Thus, these fields 192 and 194 in combination with field 102 of a record 100 may unequivocally identify message originators and recipients. Each record 190 further includes a field 196 containing data representing a message to be received by the intended recipient. The data may be text, voice or other data. Optionally each record 190 may contain additional fields containing such additional information as the date and time of a message, its urgency, whether the message has been received, and the like.

Accounts database 28 preferably stores administrative data for end-users of database server 18. Accounts database 28 preferably contains a plurality of account records 140 each also associated with a known user of system 10 as illustrated in FIG. 3A. An example account record 140 is illustrated in FIG. 3D. As illustrated, each account record 140 includes several fields that contain administrative information about a particular user. Specifically, account record 140 preferably includes a UserID field 142 and service provider ID field 144 containing the same unique identifiers stored in fields 102 and 104, respectively, of record 100 (FIG. 3B). Field 144 again identifies the service provider with which a user is associated.

As will become apparent, database server 18 may calculate user access charges based on rates established by each service provider. Charges may be stored in a service provider record, as detailed below. Calculation of charges is also described below. Record 140 preferably further includes name field 146 containing the true name of an associated user, and address field 148 storing a contact address of that user. Credit field 150 includes a total credit amount paid by the user to his or her service provider. Field 150 may be populated upon creation of a user account, and replenished from time to time.

Service provider database 30 (FIGS. 1, 3A) preferably contains a plurality of records 160 each containing information associated with a service provider using system 10. Service provider database 30 preferably stores data pertaining to the individual introduction service providers using database server 18, and in particular data identifying the total charges attributable to all users associated with a service provider using the provider's services. Data stored in database 30 controls the overall operation of system 10, for users associated with a particular provider. Moreover, database 30 may be used by an operator of system 10 to asses earnings that individual service providers have earned from their users.

An example service provider record 160 is illustrated in FIG. 3E. As illustrated, each example record 160 includes a service provider ID field 162 containing the same unique identifier stored in fields 104, and 144 of records 100 and 140 (FIG. 3B, FIG. 3D), respectively. Record 160 preferably also includes service provider name field 164 containing the business name of the service provider associated with record 160, as well as address field 166 storing the business address of that service provider to where the detailed earnings and amounts-owing statements are to be sent. Total earned charges field 168 contains the total charges that the service provider associated with record 160 billed its users. Record 160 further contains field 176 containing additional service provider data, including for example, a rate structure for users, and a pointer to a an associated service provider HTML page, stored as a record 200 (FIG. 3A) within database 32.

Record 160 further includes two data structures, exemplified by field 172, storing example user access bit masks, that identify service providers that allow pooling of messages to the benefit of their respective users. Specifically, example field 172 stores a bitmask including a plurality of bits. One bit is associated with each service provider that uses system 10. As such, in the example embodiment, the mask in field 172 has length equal to at least the number of providers supported by system 10. As will become apparent, masks in fields 172 associated with each service provider are used by server 18 to allow or deny users' access to greetings of other service providers. A bit in a mask in field 172 having a value of one (“1”) signifies that users associated with the service provider identified by the users' personal information record 100 have access to users of the service provider identified by the bit. As will become apparent, the bit mask in fields 172 may be used to limit user access across service providers hosted by server 18.

Further, an additional field 174 stores a further service provider interest bit mask within each service provider record 160. Each bit represents a user interest type, to which a user of the service provider associated with record 160 should not have access. As noted, user interests of individual users are identified by field 124 of a user record 100 (FIG. 3B). As will become apparent, service provider interest bit mask in field 174 may allow a service provider to prevent its users from having access to other users whose interests are not endorsed by the service provider. The bit mask in field 174 identifies prohibited interests of other users. For ease of comparison mask 124 and mask 174 include a like a number of bits.

An example service provider record within HTML database 32 is illustrated in FIG. 3F. As illustrated, each record 200, includes a field 202 containing an identifier of an associated service provider, and a field 204 containing HTML data used by server 20, in the provision of data and voice prompts to users associated with the associated service provider.

Those skilled in the art will appreciate that many other possible fields may be included in records 100, 140, 160, 180, 190, and 200. Further, it will be appreciated that the fields included in records 100, 140, 160, 180 and 190 may be structured in many ways, and that the records in databases 24, 26, 28, 30, and 32 can be organized in many different ways.

Databases 24, 26, 28, and 30 are preferably stored on an alterable storage medium, such as a hard disk drive, which may form part of server 18. Databases 24, 26, 28, and 30 are managed and maintained by server 18 which may further store and execute a database engine such as an SQL server, Dbase, or other suitable software designed to manage and maintain the information stored within databases 24, 26, 28, and 30.

As will be appreciated, although illustrated as separate databases, each of databases 24, 26, 28 or 30 could be stored within a separate database table within a single database stored at server 18.

So, IVR server 16 may be programmed to play a series of voice prompts to a user, and collect responses from the user in the form of DTMF tones, in a conventional manner. The flow and sequence of prompts, as well as permissible responses are controlled by software provided by individual service providers. This software may be stored at IVR server 16 and within a record 200 of HTML database 32 associated with a service provider.

In practice, different service providers using system 10 preferably advertise their services as provided by system 10 in several media, such as newspapers, television, radio, Internet, and other possible media outlets. Advantageously, individual service providers could co-ordinate their advertising campaigns by deciding in advance which media outlets each service provider should advertise in, thereby reducing the overall advertising cost borne by individual service providers. Preferably, the featured ads can include information about a service provider's service, and either a phone number or a URL that new and registered users may use to access the service. In order to entice new users to register, a service provider's advertisements may include samples of greetings composed by its users on system 10. A service provider's advertisements need not inform potential users that the service provider is only one of several service providers offering their services through system 10. Users are simply not typically informed of the hardware or methods used by each provider, as these are typically sufficiently transparent.

A new user seeing an ad promoting the introduction service of one of the service providers using system 10 may access system 10 by following the access instructions listed in the ad. If a service provider has promoted a telephone-based introduction service, the service provider would provide a telephone access number in its ad. For example, the service provider may provide phone number 555-0001 which would become the number used by users subscribing to that service provider. Subsequently, prospective users, using, for example, telephone 54, 56, or 58, dial the telephone number provided by the service provider of choice.

Alternatively, each service provider may also allow users to access system 10 through data network 12. If a service provider facilitates this form of access, the service provider may provide a unique URL address in its advertisements that allows the service provider's users to access system 10. A user subscribing to the service provider's introduction service using one of workstations 38, 40, or 42 may enter the URL at the appropriate field on the web browser installed on the workstation, whereupon a link between the workstation and server 18 or server 20 may be established.

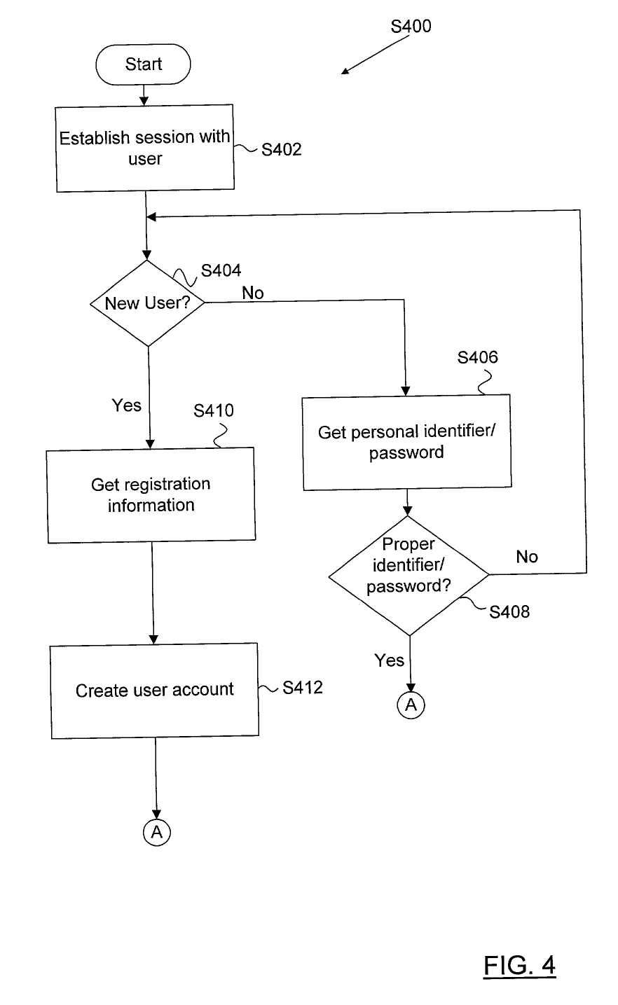

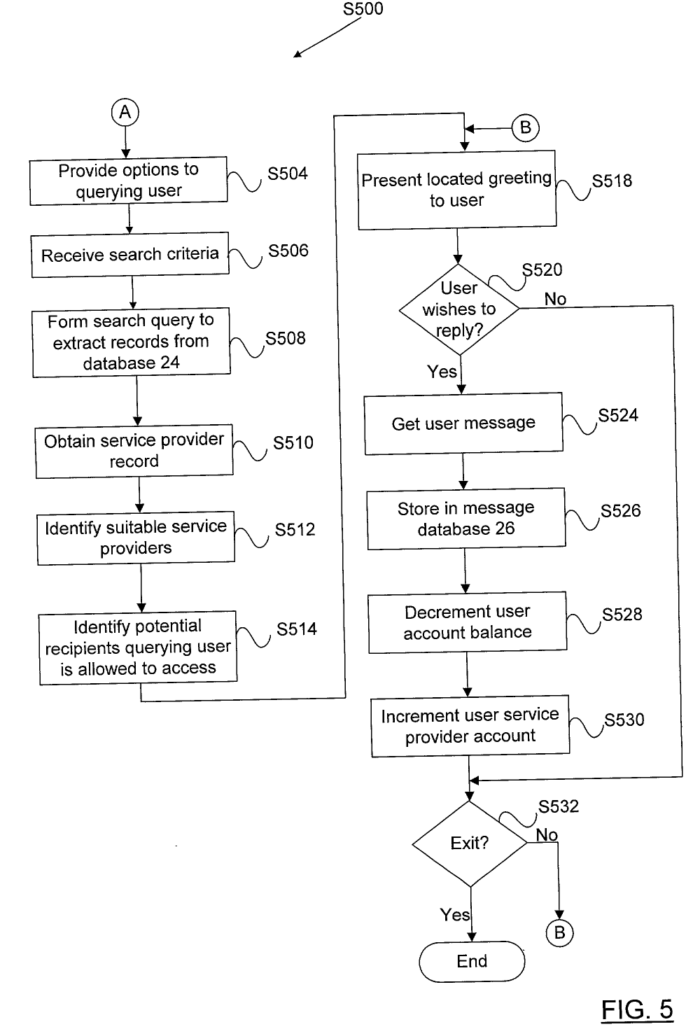

Steps performed at system 10 to allow a user accessing system 10 through an access link associated with one of the service providers of system 10 to register and use system 10, exemplary of an embodiment of the present invention are more particularly illustrated in FIGS. 4 and 5. For simplicity, steps illustrated in FIGS. 4 and 5 may be equally applicable to access by way of data network 12, as well as by way of telephone network 14.

So, a link between system 10 and the example user, using either workstations 38, 40, or 42, or telephone 54, 56, or 58, is established in step S402. Next, system 10, under software control prompts a user to enter an identifier or request new registration in step S404. Server 18, in effect assesses if a user is a new user, or a repeat user in step S404.

In the event the user is a repeat user, the user is prompted for his or her personal identifier for authentication, in step S406. If the user is properly authenticated, as determined in step S408, steps S504 and onward are then performed. If on the other hand, a user is a first time user, user registration is effected in steps S410.

If the example user accesses system 10 through a workstation (e.g. workstation 38, 40, or 42), server 18, acting as a conventional HTML web server, provides workstation 38 a registration form web page stored at server 20, preferably in HTML or Java script, soliciting required information in step S410. The web page provides workstation 38 a unique HTML page corresponding to the service provider that the user wishes to subscribe to, as stored within a record of database 32 associated with the contacted service provider. As will be appreciated, if other users register by accessing server 18 through URLs corresponding to different service providers, server 18 would transmit corresponding HTML pages corresponding to the different service providers. A user may then complete relevant fields on the HTML page, including such information as name, home address, age, credit card number, and the like. The completed page may be submitted and provided to server 18. The contents of the page may then be used by server 18 to populate fields of record 100. Optionally, the user may provide a prerecorded, greeting using an associated microphone and suitable software. This greeting may be used to populate field 126 of record 100, or a record 190 of database 26.

Similarly, if an example user accesses system 10 using telephone 54, 56, or 58 by establishing a communications link with IVR server 16 by way of telephone network 14, IVR server 16 may initiate a registration sequence in step S410 by transferring the call to a telephone call center (not shown). The call center may prompt the user for his/her name, address, age, credit card number, and the like. This information may be used by a call center agent using a remote terminal in communication with system 10 to create a user record 100 and populate of appropriate fields. Next, upon first contact with server 16, the user may be prompted by VRU 80 to provide a voice greeting used to populate fields 126 (not specifically illustrated).

In response to receiving the user information, either from the user or from a call center operator, in step S412 server 18 uses the received information to create a suitable User ID and create associated records 100 and 140 in databases 24 and 28 respectively, thereby effectively creating an account for that user. Server 18 may also assign or prompt a password or personal identification number that the user may enter in order to later access the created account. User ID and password may be stored in fields 102 and 106, respectively, of an associated user record 100. Server 18 preferably also populates fields 104 and 144 of record 100 and record 140 with an identification number of the service provider the user has registered with in accordance with the URL or telephone access number that was used by the user to access system 10. Similarly, server 18 populates field 124, to reflect pre-determined preferences of the user.

Field 150 of record 140 may be populated with an amount representing a pre-payment by the user. Pre-payment may be effected by credit card, cheque or otherwise. Once any pre-payment is exhausted, server 18 may prompt for additional payment. Steps performed to request additional payment are not illustrated, but will be understood by those of ordinary skill.

Once registered, the example user may use and access system 10 in order to browse greetings of others, and potentially leave messages for those others. After being authenticated in steps S406 and S408, example steps S500 exemplary of an embodiment of the present invention, illustrated in FIG. 5, are performed. For the purposes of the example, the example user will be referred to as the querying user, and will be identified by UserID=querying_user.

So in step S504 system 10 provides the example querying user information about the features and options available to users using the service provider's services. The particular features and options that may be available will of course vary from one service provider to another. Thus, a querying user subscribing to the services of a particular service provider may be limited in how that user may interact with system 10 by those features and options that are offered by that service provider. As noted, control of presented features and options may be governed by the contents of field 176 and an associated HTML record 200 within HTML database 32, particular to each service provider.

If the querying user accesses system 10 through workstation 38, 40, or 42, the available features and options will be provided to the user by way of an HTML page associated with the particular service provider.

If the querying user accesses system 10 through telephone 54, 56, or 58, available features and options will be spoken by VRU 80. The querying user may then make his/her selections and enter information by pressing the appropriate keys on telephones 54, 56 or 58 causing selections to be sent as DTMF signals. Example options could allow the querying user to update his or her personal greeting, retrieve messages left for the user, obtain account information, or exit. For clarity these options are not detailed in FIGS. 4 and 5.

Typically, a querying user will also be able to browse the greetings of other users identified by database 24. As system 10 provides introduction services for multiple service providers, the querying user need not be limited to browsing greetings that originate with users of the same service provider. Instead, as will become apparent, a querying user may browse greetings of many or all users hosted by system 10. So greetings stored at system 10 may be classified as either originating with users of the same service as the querying user or with users of other service providers. System 10 stores a first plurality of greetings associated with the introduction service provider of the user and a second plurality of greetings associated with users associated with other service providers.

As should be apparent, each service provider may allow greetings to be browsed by user preferences. Preferences may be input by way of DTMF tones, in response to voice prompts, recognized by VRU 80 (FIG. 1). For example, a user may input an age or gender preference. Based on the prompts and user responses, query criteria may be generated at system 10. In the event the querying user accesses system 10 by way of data network 12, the user preferences may be input by way of completed HTML form.

Thus, in steps S504 and S506, system 10 prompts the querying user for input and receives the user's browsing selections. User selections received at IVR server 16 in the form of DTMF signals are converted by VRU 80 into computer data compatible with server 18, and then forwarded to server 18. In the event a user is accessing system 10 by way of data network 12, user browsing selections are sent from one of workstations 38, 40 or 42, to system 10, as a result of completing a HTML form.

Optionally, user browsing selections may be prompted each time a user contacts system 10, or prompted at initial user registration and stored within a record 100 of user database 24.

Once user preferences are obtained, queries of databases 24 and 30 are processed by server 18 in step S508-S522.

Specifically, in steps S508-S514, server 18 forms a suitable query to extract records from database 24. In step S508, server 18 forms an initial query parameter to more particularly identify the querying user. That is, the following SQL query may be initiated in steps S508

SELECT * FROM database 24, WHERE UserID=querying_user.

From the resulting record associated with the querying user, server 18 may determine the service provider ID of the querying user, and obtain the corresponding service provider record from database 30.

That is, server 18 may obtain the service provider record 160, by executing the SQL query in step S510,

SELECT * FROM database 30, WHERE serviceprovider_ID=serviceprovider_ID of querying user

Now, using this information and specifically fields 172 and 174 of the retrieved record 160, a user query may be generated.

Specifically, all records within database 24 of users with sharing service providers, and sanctioned preferences are retrieved.

Suitable service providers may be identified in step S512 by decoding user bit mask in field 172 of the querying user's service provider to identify the service providers with which the querying user's service provider permits sharing.

That is,

shared_providers=[ValueBit0 (Mask 172) AND service_provider_[ID0] OR [ValueBit1 (Mask 172) AND service_provider_ID1] . . . OR [ValueBitn−1 (Mask 172) AND service_provider_IDn−1]

Next, the query is further narrowed to users with interests corresponding to the querying user, and further sanctioned by the querying user's service provider.

That is,

interests=user_interests NOT prohibited_interests

So, the users of system 10 matching the user's query, and sanctioned by the user's service provider may be found by initiating a single database query of database 24 and corresponding greetings in database 34 in step S514 with

SELECT * FROM database 24 where (Service_ProviderID =shared_provider [field 204] AND preferences [field 224]=interests

Put another way, the comparison of the contents of field 172 of the service provider of the querying user allows server 18 to limit user access across service providers co-hosted by server 18. All this is, of course, transparent to end-users who need not realize that they have or do not have access to users of other service providers.

Field 174 associated with the querying user's service provider stores user interests that identify users that are incompatible with the interests of the querying user's service provider. In this way, the querying user's service provider can filter messages of other users whose interests are incompatible with those of the service of the service provider, based on the users' profiles. An introduction service could thus limit access to users whose interests are contrary to the interests of the majority its users. This comparison is effected by logically ANDing the value of field 174 of the user's service provider with field 124 of record 100 of other users. If the result is non-zero, the other user is excluded from the query.

Use of a mask within field 174 allows service providers to further control user access to greetings of users of other providers. So, for example, users of one service provider may only be allowed access to users who have interests deemed acceptable. So, a user of an introduction service that promotes long-term relationships may also have access to greetings of suitable users of another service provider that also has users interested in more casual or risque encounters. However, users of that other service provider seeking casual relationships will be excluded.

In any event, once a query identifying potential recipient users has been formulated, suitable records of database 24 and database 34 corresponding to the query may be retrieved in step S514. One or more of the located greetings is presented to the querying user in step S518. In the event system 10 has been accessed by way of telephone network 14, the greetings may be re-played sequentially using VRU 80. In the event the user has accessed system 10 by way of data network 12, system 10 may present links to all located greeting by way of an HTML index page.

After being presented a greeting, the user is given the option to respond to a presented greeting to initiate communications with the originator of the greeting in step S520. If the user chooses to respond, as assessed in step S520, the user may leave a message for the recipient user in step S524, that is stored in the database 26. As well, in step S528 a charge is levied to the user's account. Specifically, field 150 of the user's record 140 (FIG. 3D) may be decremented a set amount. Field 150 may be decremented a fixed amount, or a variable amount, based for example on, the service provider, on the length of time of the response, or the like. At the same time, the user's service provider's net collected charges as tallied in field 168 of record 160 (FIG. 3E) for the service provider associated with the user is incremented in step S530, to reflect the charges accrued by the user. In the event a user runs out of credit, he or she may be requested to provide additional funds. Specific steps to request additional funds are not illustrated.

After the user has responded to any particular greeting, the user is given the option in step S532 to exit or to view or listen to additional greetings. If the user chooses to view of listen to additional greetings, step S518 and onward are repeated.

At a later time, the contents of field 168 may be used by an operator of system 10 to tally the value of services provided by the operator of system 10 to service providers hosted at system 10. Charges to the various service providers sharing system 10 could be levied accordingly.

As will be appreciated, while the organization of hardware and software components, databases and directory structure have been illustrated as clearly delineated, a person skilled in the art will appreciate that this delineation and organization is somewhat arbitrary. Numerous other arrangements of hardware, software and data are possible. For example, database server 18 and IVR server 16 could be combined into a single unit whereby that unit would have similar components as those described in relation to server 18 and IVR server 16. Similarly, databases 24, 26, 28, and 30 could be organized in numerous ways, using relational or object oriented structures. Similarly, data stored in such databases could be stored in numerous equivalent ways. Masks stored in fields 172, 174, and 124 could be replaced with alternate structures, allowing storage of similar or identical information, such as for example arrays, short integers, or the like.

Those of ordinary skill will appreciate that many components of system 10 could easily be integrated. Servers 16, 18, 20 and 22 could, for example, be combined into a single unit having necessary components.

Further, it will also be appreciated by those skilled in the art that any one of workstations 38, 40, or 42, as well as any one of telephones 54, 56, or 58, need not be interconnected to system 10. Rather, any of the workstations or telephones may be interconnected to an intermediate server associated with one or more of the service providers, which may in turn be interconnected to server 20 via data network 12 or telephone network 14.

It will be further understood that the invention is not limited to the embodiments described herein which are merely illustrative of a preferred embodiment of carrying out the invention, and which are susceptible to modification of form, arrangement of parts, steps, details and order of operation. The invention, rather, is intended to encompass all such modification within its scope, as defined by the claims.

What is claimed is:

1. A method of facilitating exchange of messages at a computerized message exchange system, comprising:
storing a first plurality of greetings at said system, each of said first plurality of greetings associated with users of a first introduction service provider;
storing a second plurality of greetings at said server, each of said second plurality of greetings associated with a user of an introduction service provider, different from said first introduction service provider;
allowing users associated with said first introduction service provider, access to selected ones of said second plurality of greetings, based on criteria associated with an originator of each of said selected ones of said second greetings, and criteria set by said first introduction service provider.

2. The method of claim 1 wherein
said allowing limits said second plurality of greetings to greetings associated with users of introduction service providers authorized by said first introduction service provider.

3. The method of claim 2, wherein
said allowing limits said second plurality of greetings to greetings associated with users having interests sanctioned by said first introduction service provider.

4. The method of claim 2, wherein
said allowing comprises using data stored within a first field at said server, and associated with said first service provider, to determine users of which other service providers are authorized by said first introduction service provider.

5. The method of claim 4, wherein
said allowing comprises using data stored in a second field at said server, and associated with said first service provider, to determine said interests that are sanctioned by said first introduction service provider.

6. The method of claim 5 wherein said allowing comprises
generating a database query, and querying a database of user records to extract said selected ones of said second plurality of greetings.

7. The method of claim 6 wherein said first field contains a binary mask.

8. The method of claim 7 wherein said second field contains a binary mask.

9. The method of claim 7, wherein said allowing comprises determining service provider identifiers corresponding to said binary mask in said first field.

10. The method of claim 1, further comprising permitting a user of said first service provider to send a message to said users associated with said selected ones of said second plurality of greetings.

11. The method of claim 10, further comprising levying a charge for sending said message, and tallying a total of charges for users associated with said first service provider.

12. A message exchange system, comprising computer readable memory storing,:
a first plurality of greetings, each of said first plurality of greetings associated with users of a first introduction service;
a second plurality of greetings, each of said second plurality of greetings associated with a user of an introduction service, different from said first introduction service;
software allowing users associated with said first service provider, access to a selected one of said second plurality of greetings, based on criteria associated with an originator of said selected one of said second greetings, and criteria set by said first service provider.

13. The system of claim 12, further comprising a database storing records associated with each of said users associated with said first service provider.

14. The system of claim 13, wherein said software generates database queries, and queries said database to extract said selected ones of said second plurality of greetings.

15. The system of claim 12, further comprising an interactive voice response (“IVR”) unit, for obtaining instructions from said user by way of a telephone network.

16. The system of claim 12, further comprising a network data interactive for obtaining instructions from said user by way of a data network.

17. Computer readable medium, storing processor executable instructions, that when loaded at computerized message exchange system comprising
a processor, adapt said computerized message exchange system to:
store a first plurality of greetings at said system, each of said first plurality of greetings associated with users of a first introduction service provider;
store a second plurality of greetings at said server, each of said second plurality of greetings associated with a user of an introduction service provider, different from said first introduction service provider;
allow users associated with said first introduction service provider access to selected ones of said second plurality of greetings, based on criteria associated with an originator of each of said selected ones of said second greetings, and criteria set by said first introduction service provider.
